(19) United States
(12) Patent Application Publication
(10) Pub. No.: US 2010/0157021 A1
(43) Pub. Date: Jun. 24, 2010

(54) METHOD FOR CREATING, STORING, AND PROVIDING ACCESS TO THREE-DIMENSIONALLY SCANNED IMAGES

(76) Inventors: Thomas G. Abraham, Miami, FL (US); Henry Gonzalez, Miami Springs, FL (US)

Correspondence Address: FELDMAN GALE, P.A., 1700 Market Street, Suite 3130, Philadelphia, PA, 19103, US

(21) Appl. No.: 12/717,553

(22) Filed: Mar. 4, 2010

Related U.S. Application Data
(63) Continuation-in-part of application No. 12/632,109, filed on Dec. 7, 2009.
Application No. 12/632,109 is a continuation-in-part of application No. 11/873,679, filed on Oct. 17, 2007, now Pat. No. 7,656,402.
(60) Provisional application No. 60/865,852, filed on Nov. 15, 2006.

(51) Int. Cl. H04N 13/02; G06T 17/00

(52) U.S. Cl. 348/47; 345/420; 348/E13.074

(57) ABSTRACT

A method is provided for creating, storing, and providing access to three-dimensional (3D) image files for subsequent use in virtual world environments. The method includes receiving 3D data generated through scanning of a person or object; recording and formatting the data into a digital image file; storing the digital image file in a 3D digital image file library located in a machine readable storage; providing access to the 3D digital image file library; retrieving the digital image file from the 3D digital image file library; and uploading the digital image file into an interactive virtual world environment.

### CROSS-REFERENCE TO RELATED APPLICATIONS

This application is a continuation-in-part of U.S. patent application Ser. No. 12/632,109, incorporated herein by reference, which is a continuation-in-part of U.S. patent application Ser. No. 11/873,679, incorporated herein by reference and which claims the priority benefit of U.S. Provisional Application No. 60/865,852 filed on Nov. 15, 2006.

### FIELD OF THE INVENTION

This invention relates to the field of the creation, storage, and access of three dimensionally scanned images of persons or objects for use in virtual world environments.

### BACKGROUND OF THE INVENTION

The use of current scanning technology to create a three-dimensional (“3D”) image of a person or object is known in the art. The use of a person's 3D image, or avatar, in various virtual world environments is also known in the art. For example, U.S. Patent App. No. 2008/0163054 teaches the use of a virtual avatar to evaluate product designs and consumer purchase decisions in virtual world environments. U.S. Patent App. No. 2003/0172174 provides a “virtual space” representing a product catalog, wherein the user can interact with the product catalog, through a personalized or default avatar.

However, the prior art does not disclose a method of storing a 3D image of a scanned object or person into a secured database, and furthermore, providing access to the secured database so that a registered user may thereafter use the stored image in a virtual world environment.

### SUMMARY OF INVENTION

The present invention defines a convenient, user-friendly solution for the creation, storage, and access of 3D scanned images so that a user with no prior experience with 3D imaging can easily create at least one 3D scanned image and subsequently access the image for use in various virtual world environments, either from their personal computer over the Internet or by visiting a retail store or third-party vendor location.

A user may interact with the system of present invention through a remotely-accessible user interface via the Internet or at a retail or third-party location, for example. The user may upload digital images and convert 2D images into 3D images, upload a digital image of a customizable video game and/or virtual world character, or scan a person or other model using a 3D scanner. Once uploaded, the 3D image is stored in a secured database.

The present invention allows users to access 3D images from a secured database and load their 3D images into an interactive 3D virtual environment.

### BRIEF DESCRIPTION OF THE DRAWINGS

The invention is illustrated by way of example, and not by way of limitation in the figures of the accompanying drawings, in which:

FIG. 1 is a flow diagram of one embodiment of the system in which the different embodiments of the present invention may operate.

FIG. 2a is an overhead view of one embodiment of the present invention deployed at a retail store where users may purchase 3D models or create 3D images using 3D scanning cylinders.

FIG. 2b is a first-person view of one embodiment of the present invention accessed from a retail store.

FIG. 2c is an illustration of one embodiment of a Body Scanning Image card.

FIG. 3 is a flow diagram of one embodiment of a Digital Lock Box system.

FIG. 4 is a flow diagram of one embodiment of a Mobile-PMP File Uploader system.

FIG. 5 is a flow diagram of the functionality of one embodiment of the 3D body and foot scanning cylinders.

FIG. 6 is a flow diagram of one embodiment of a Distributed Parallel Computing Scanning system.

### DETAILED DESCRIPTION OF THE INVENTION

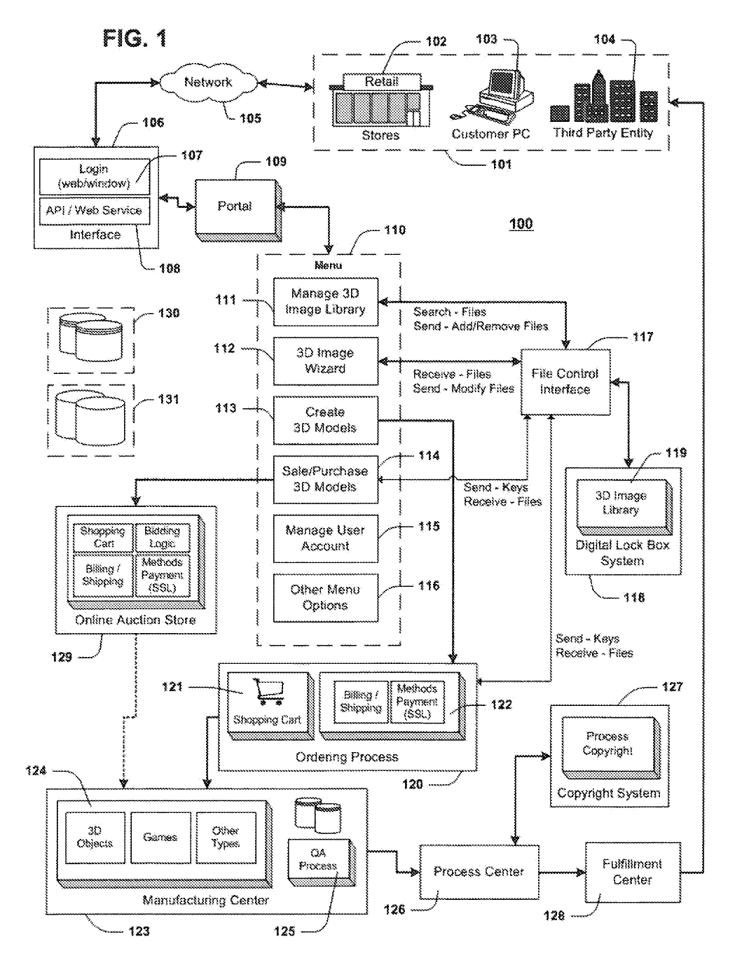

FIG. 1 shows a diagram of the system 100 processes in accordance with one embodiment of the invention. The system 100 may interface with multiple users 101 through one of the following means: a retail store 102; a customer home PC 103; or a third-party entity 104.

The interface 106 to the system 100 is accessible over a wide-area network (WAN) 105, such as the Internet, extranet, LAN, satellite communications or a suitable equivalent thereof. The World Wide Web environment also known as “the Web” may be used to exchange data or transact business. Users can connect via a personal or network computer, workstation, minicomputer, or suitable equivalent thereof using any applicable operating system.

In one embodiment, the communication medium between the system 100 and the various users 101 is a direct link via a network interface 105 or via the Internet 105 using a commercially available browser. In one embodiment of the present invention, the user connection to the system 100 may use a system to protect server data and algorithms from unauthorized access by intruders.

In another embodiment of the present invention, the system 100 architecture may use an N-tier and/or service oriented approach, implemented in a multi-platform (platform independent) format using any high-level programming language. Information stored by the system 100 may be stored in a computerized database 130, such as a relational, hierarchical, model-oriented database, or any equivalent thereof. The system 100 storage devices 131 (e.g., optical discs, magnetic storage-like hard disks) may be implemented using any acceptable storage architectures. The system 100 is not limited to the type of documents and applications described herein that might be used to interact with the user.

In one embodiment, the interface 106 is the gateway or entry point to the system 100. User several ways may enter the system 100 by several means. In one embodiment, users may log in through a web page 107 or via an application interface or web service 108. The log-in web pages 107 will have markup language-based information, such as hypertext markup language (HTML), extensible markup language (XML), or a suitable equivalent thereof. The log-in web page 107 may request the user to enter their log-in information. In one embodiment, the user's identity may be authenticated via a password and a personal identification number (PIN). If the user is not a member of the system 100, a subscription-based membership and registration web page may load allowing the user to register to become a member.

In another embodiment of the present invention, the users agree to assign the right to his or her 3D image with respect to all aspects of their image. When the user completes the subscription-based membership and registration, the system administrator and the new user will receive notification of membership. The new user membership information may be stored in several databases 130 and the new user's personal, portal 109 is created. Once the user's membership information is registered in the system 100, the user is directed back to the log-in web page 107. Here, the user supplies new log-in information to enter the system. If a user enters invalid log-in information, the system 100 may alert the user of the error. Users who are validly logged in will be taken directly to their personal portal 109.

In another embodiment of the invention, the user may connect through a third-party entity 104 (e.g., retail business, partnerships, corporations, companies, non-profit organizations, etc.). The interface 106 may use web services 108 in conjunction with extensible mockup language (XML), simple object access protocol (SOAP), and/or any equivalent thereof, which provide a medium for companies to communicate via their servers to the system 100. In this particular embodiment, the user does not need to interact with the system 100 directly, but may also interact via the third-party entity's 104 online retail website. A third-party entity 104 may embed the system 100 inside their web site while still providing the user the option to manage models and images. By making the system 100 a part of the third-party's website, the third-party entity 104 eliminates the need to add special features to their own site to accommodate the users. Additionally, the system 100 may be customized to blend in with a third-party's web site theme.

The portal 109 is the core navigation menu system 110 which provides the user with numerous options, including but not limited to the following: managing personalized 3D digital image files 111; the 3D image wizard 112 which allows the user to alter and/or create new 3D images from a user's existing 3D image library 119; and/or managing a membership account 115. A third-party entity that is interfacing with the system 100 may limit or expand the menu options available to users on their web site.

The ability to manage 3D image files 111 is another aspect of this invention. Users can manage their own 3D image library 119 via the file control interface 117 of the digital lock box system 118, for example, users can group their 3D images by category (key words defined by the user), by image file name, by image file date, by available images that have not yet been manufactured, and by images that have already been manufactured. Users can add new 3D images to their library 119 by uploading valid image files that meet the file format requirements of the system 100. The images are then stored in the user's private account in the digital lock box system 118.

In another embodiment of the present invention, a third-party entity 104 interfacing with the system 100 has the option to transfer specific 3D images that the customer selects on the third-party web site. Before transferring any images to the system 100, a user preferably should first have an account. For new customers, the third-party entity 104 transmits the customers' membership information via the API/web service interface 108 for registration in the system 100. Once the membership information is available, the third-party entity 104 uses this information to interface 106, 108 with the system 100. Then, the selected images on the third-party web site may be placed into the user's system digital lock box 118 user account. In one embodiment, a “push” technology over a secure wide-area network (WAN) used by the third-party entity 104 may be implemented to send the 3D images to the system 100 servers. Other technologies, such as web or window services 108 may also be implemented. The process uploads the files automatically to the digital lock box system 118 while updating the user's image library information in the database. The images may then be viewed in the user's 3D image library 119.

In another embodiment of the invention, a 3D Image Wizard 112 may contain software that allows a user to modify or enhance an existing 3D image's geometry and texture information into a new 3D image file which is then stored back into the user's digital lock box 118 account. Rendering software may be accessed by a user through the system to allow the user to convert a 2D image into a 3D image. The wizard 112 allows users to add realistic or aesthetic depth to a 3D image through a process known as “texture mapping,” “mapping,” or “applying.” A texture map may be represented by a bitmap or other picture file formats such as JPEG, GIF, TIFF, or a suitable equivalent thereof. For example, the artwork of a painter may be scanned or photographed to a bitmap and then mapped onto a sculpture-like 3D image. This mapping can be accomplished through the use of any commercially available software tool.

In another embodiment, the menu system 110, includes an option to manage the membership account 115 where the user can update and/or change their user information.

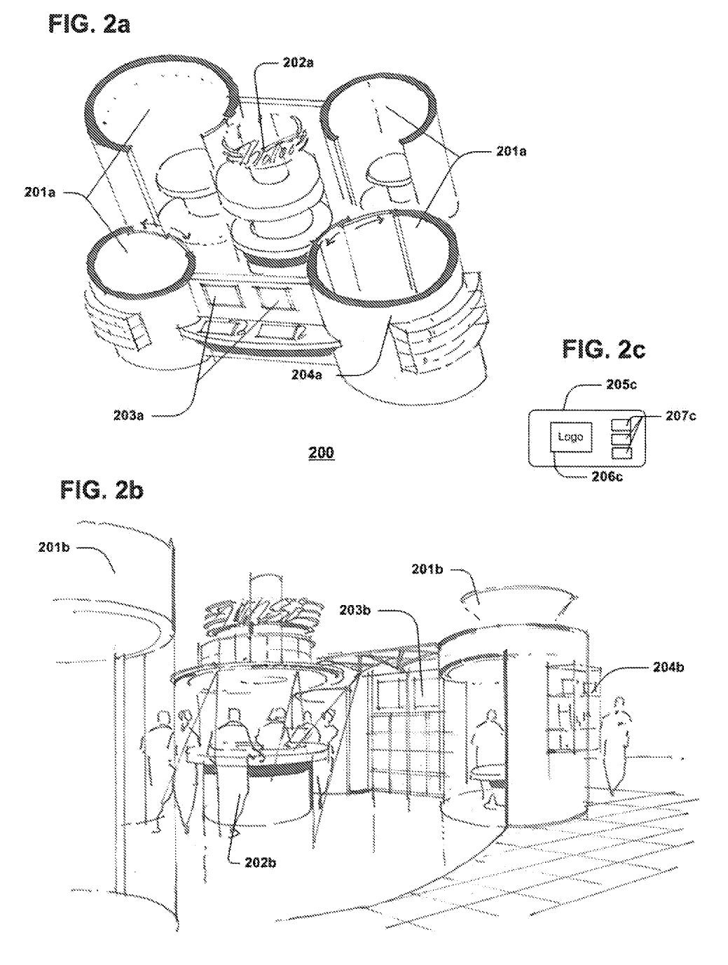

FIG. 2A and FIG. 2B both illustrate another embodiment of the invention in various angles. The retail store 102, 200 may serve as a vehicle to bring together various users (e.g., customers) with various vendors and retailers in a digital retail environment that will allow them to buy, sell, market, advertise, and exchange products through the system 100. When the user goes to the retail store 102, 200 for body or model scanning, prior to any scanning, the user should preferably have a membership account in the system 100. If it is a new user the user should preferably register as a member in the system 100 via any of the computer workstations 203a, 203b at the retail store 102, 200. Each retail store 102, 200 may have a direct link via a network interface or via the Internet that has access to the system 100.

When the user is ready to create a 3D image, the user may present the membership number to the customer service technician and then the user enters the 3D image capturing cylinders 201a, 201b to create a digital 3D image. Also, the user may bring other non-human objects to scan for creation of 3D images.

The 3D imaging cylinders 201a, 201b may be implemented as 3D color or black/white body or foot scanners that generate a 3D point cloud of the user or object. This 3D point cloud is generally composed of several million 3D points of data to assist in creating an accurate rendering of the 3D model. Since the scanning device 201a, 201b can record color and texture; it provides a realistic 3D image of the user or object. The user or object is simply positioned in the center of the 3D imaging cylinder, within a circle which has been marked for ensuring equal measurements between the scanning columns 201a, 201b, while a digital source or any equivalent thereof scans to collect the necessary data to create a 3D image. In addition to color and texture, the scanning device 201a, 201b is also capable of recording the mesh and movement of the scanned user. The scanning device 201a, 201b can be composed of several types of camera devices, including but not limited to: laser or digital source for full body color scanning; photo capturing camera for close-up 3D facial detail data; motion camera that records the movements of the user during a period of time. These camera devices allow the ability to scan different range of data of the user or object. The motion capturing camera device can store the 3D point clouds of each frame per second during the user's movements inside the 3D imaging cylinders 201a, 201b. When scanning device 201a, 201b is done capturing the user's movements, the customer can use system 100 to review the complete scanned motion file and select the particular frame that he or she would like to generate into a 3D product.

When scanning is complete, the user can view the results of the 3D image on the computer monitors at the customer service stations 202a, 202b. When the user decides which 3D image(s) to save, the user pays for the scanning service. Then, the retail store technician transfers the 3D image(s) into the user's system digital lock box 118 user account. The user has the option to place the order while being at the retail store 102, 200 using one of the computer workstations 203a, 203b to gain access to the system 100, or simply place the order at a later time.

FIG. 2C illustrates another embodiment of the present invention where the user (e.g., customer) visits one of the stores 102, 200 and has the option of receiving a body scanning image (“BSI”) card 205c that records certain information about the user's BSI. While receiving the BSI card 205c, the user may enter a unique BSI PIN at a customer service station 202a, 202b in the retail store 102, 200 to secure card access. The card may record and contain information such as the following: the BSI PIN; user name; body-shape information (i.e., body measurements or sizes); membership information; and anything else a customer would need when they visit any third-party entity that has an agreement with the retail store 102, 200. This electronic card 205c may either have a magnetic storage medium and/or microprocessor chip that is compatible with magnetic card readers (i.e., credit card, debit card), smart card reader (i.e., smart card), or any other technology available to allow the storage of all necessary body shape information on the card. Each third-party entity that has an agreement with the retail store 102, 200 may have a card reader device that interfaces with the system 100. When the user visits one of these third-party entities, the user may swipe or insert the electronic card 205c (depending on the electronic card reader technology being used) at the customer service counter of the third-party entity and then enter the unique BSI PIN which authenticates the card user. In another embodiment, at the card reader station, a monitor (e.g., LCD, plasma, TV) may display a 3D virtual dressing room with all the apparel pieces that is recommended based on using the customer's measurements.

If the user enters the wrong BSI PIN value a specified number of times, the system 100 may lock the card access and the user has to reset the account, for example, at a retail store 102, 200. Also, this electronic card can be updated by visiting any retail store 102, 200 for a new body-shape image or to change other information stored on the card.

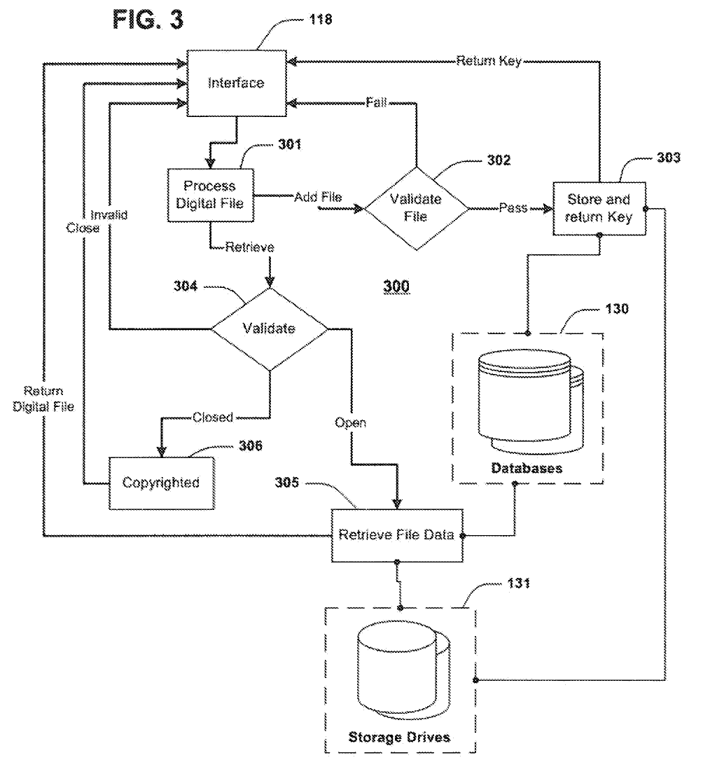

FIG. 3 illustrates one embodiment of the system 100 for locking and securing the 3D digital image files. The digital lock box system interface 118 is developed using any high-level programming language that produces an application programming interface (“API”)-compatible executable program. The API constitutes means for the digital lock box system 300 to communicate with other components in the system 100. The interface built-in logic 301 processes the request from the system 100 to add or retrieve 3D digital files. When a 3D image file is sent by the user to be added into the user's library (while inside the system 100 or via third-party entity 104), the validation engine 302 processes the file for, including but not limited to the following: file format (e.g., OBJ, STL, PLY, VRML); file size; duplications; and anything else that would restrict the ability to manufacture 3D models. A QA process 303 is applied to eliminate problems with the digital file and protect the 3D images from unauthorized copying (e.g., copyright validation process). If the 3D image file passes validation, then it is stored 303 in a storage device 131 with a unique key created from the lock box database 130. This unique key is then returned 303 and added to the user's 3D image library. Any 3D digital file that does not pass the validation returns an unsuccessful confirmation via the interface 118.

In one embodiment, the retrieving logic 304 of the lock box system validates the submission of the key that was submitted by the user while inside the system 100. If the key does not exist, the validation process 304 returns an invalid confirmation to the user via the interface 118. If the key is already used, the copyright validation process 306 notifies the user. If the key refers to copyrighted images, the validation process 306 returns a copyright confirmation to the user via the interface 118. If the key is open, then the key is processed 305 by changing the key's status (e.g., Copyright, Pending, Edit) in the database 130 and returns the 3D digital image file back to the user in the portal 109. Depending on which component inside the portal 109 is interfacing with the digital lock box system 300, the 3D image key status changes. For example, the interface from the 3D image engine 112 would change the 3D image key status to “Edit” while the interface from the shopping cart 121 would make the status “Pending.”

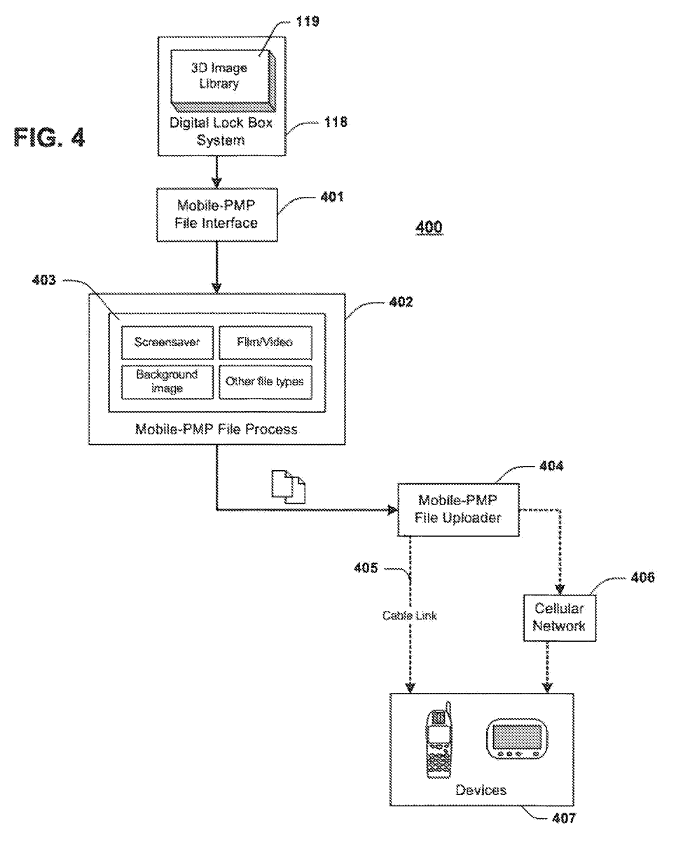

FIG. 4 illustrates another embodiment of the present invention, providing the user the option to create an assortment of 3D products for mobile and portable media player devices 407. These mobile and portable media player devices 407 should preferably have sufficient display and audio capabilities to play different types of video and digital image formats, including but not limited to the following: mpeg; 3g2; Divx; Xvid; SigmaTel Motion Video (SMV); jpeg; gif; interactive media (i.e., flash animation); or any equivalent thereof. The mobile devices 407 should have at least some basic telephony functions, including but not limited to the following: a cellular phone 407; a wireless communication device (e.g., Blackberry, Treo, PocketPC, SmartPhone) 407, or any equivalent thereof. The invention may interface with several types of portable media player devices 407, including but not limited to the following: a PMP device 407; a media player device (e.g., iPod, Creative Zen, Archos, Iriver Clix) 407; or any equivalent thereof. These portable media player devices 407 may have wireless functionalities. The mobile and portable media player devices 407 may connect via a direct cable link (i.e., in any of the stores or third-party entity facilities) 405, Bluetooth connection, or any cellular network (e.g., W-CDMA, Third Generation (3G), GSM, PDC, FLEX, CDPD) 405 using a wireless communication protocol (e.g., Wireless Application Protocol (WAP)) to download content files 403. These communication protocols interface with several types of operating systems, including but not limited to the following: PalmOS; EPOC; Windows CE; FLEXOS; OS/9; JavaOS; in-house operating system; or any equivalent thereof. These cellular networks 406 may use either a “push” or “pull” technology to deliver content to the user's mobile and/or portable media player device 407 with or without user interaction. Some examples of 3D products the user can manufacture for their mobile and/or portable media player device 407 while using a 3D image in the 3D image library include, but are not limited to the following: 3D screensavers; 3D video; short clip-films; animated background image; or any equivalent thereof 403, the applications and/or systems mentioned above are not meant as limitations to the implementation of delivering content to the mobile and portable media player devices 407.

To create the 3D product using the center 123, for either the mobile or portable media player device 407, the mobile-PMP file interface 401 retrieves the 3D image file from the users' 3D image library 119. A manufacture technician may evaluate the 3D image and apply the proper rendering process. Depending on the option the user picks for the type of 3D product for the user's mobile or portable media player device 407, different software solutions may be used. The mobile-PMP file process 402 may apply several steps, including but not limited to the following: converting a 2D image into a 3D image; “texture mapping,” “mapping,” or “applying” to manipulate the 3D image geometry points into a series of frames to create an animated short-film; and/or any equivalent thereof. The manufacture technician may use any available software tool (e.g., 3D Max studio, Autodesk Maya, Cinema 4D), or any other tool that becomes available in the future to create the user's 3D content 403. When the manufacture technician has created the 3D product, the content file is transferred to the mobile-PMP file uploader 404. The mobile-PMP file uploader 404 is the service that may be used to deliver the 3D product to the user's mobile or portable media player device 407. This service 404 may deliver the 3D product using a cable link 405, or using a cellular network 406. When the user places the order for a 3D product, he or she has the option to choose which delivery method to use.

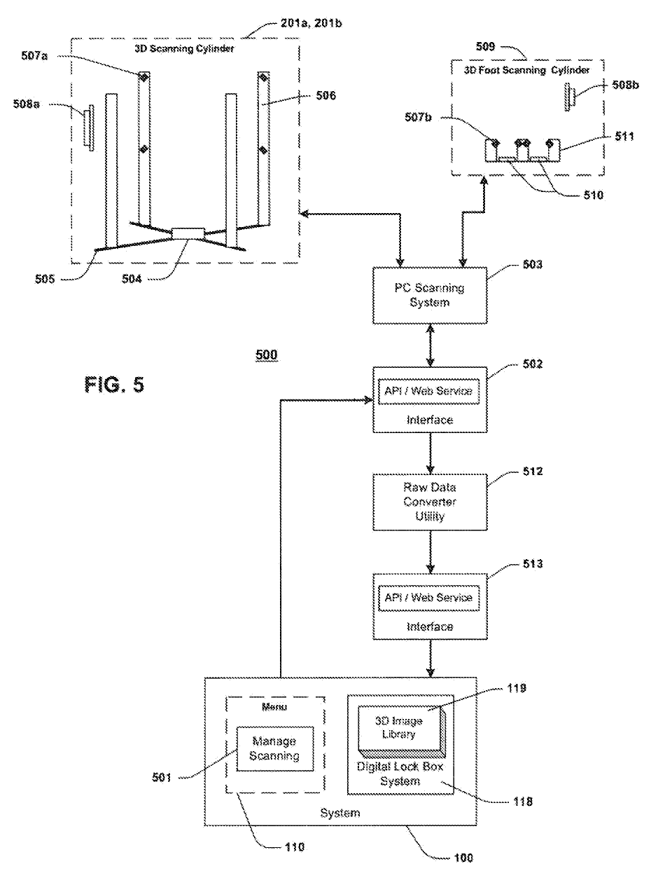

FIG. 5 illustrates an embodiment of the interface between the system 100 and the 3D image capturing cylinder 201a, 201b, and 3D foot scanning cylinder 509. In one embodiment, when the user or object to be scanned is standing on the platform 504, 510 inside the 3D imaging capturing cylinder 201a, 201b and 3D foot scanning cylinder 509, the customer service technician may log into the system 100 and accesses the managing scanning 501 feature to activate the scanning process. The technician may swipe the customer's BSI Card 205c if available, or enter information including but not limited to the following: user's membership number; number of scans; scan type (e.g., body, foot); and other specific information to store the 3D image file inside the user's 3D image library 119. The system 100 may communicate via an application interface or web service 502 and send several commands to the PC scan system 503. The first command may communicate with either the 3D imaging capturing cylinder 201a, 201b, or 3D foot scanning cylinder 509 and launch a video on the monitor (e.g., LCD, plasma, TV) 508a, 508b which may be positioned adjacent to the outside of the scanning columns (e.g., pillars) 506, 511 area. This video may be a short-clip instruction film for illustrating to the user the proper scanning pose, and responding to displaying frequently asked questions and answers thereto. As the video ends, the second command triggers and launches a count-down video or audio informing the user of the time remaining before the 3D scanning system begins scanning. When the scanning device(s) 507a, 507b complete scanning, they 507a, 507b generate a 3D point cloud of the user or object (e.g., body, foot) and transfer the raw data file to the PC scanning system 503. The PC scanning system 503 may then “push” the new raw data file to the raw data converter utility 512 via an application interface or web service 502. The raw data converter utility 512 inputs the raw data file and applies a rendering process, including but not limited to the following: converting the raw data file into a CAD file format (e.g., OBJ, STL, PLY, VRML); data compression; data cleaning; hole filling; and/or any equivalent thereof. The rendering process may output several files depending on the required file formats needed inside the system 100.

The 3D imaging capturing cylinder 201a, 201b may be comprised of several configurations, depending on the detail level of the 3D image file required to be able to manufacture the 3D model. There are several 3D scanning technologies that may be used, including but not limited to the following: stereo-matching; laser scanning; projection of white light patterns; active sensors; modeling and image processing; or any equivalent thereof. Several of the 3D scanning technologies use columns (e.g., pillars, metal poles) 506, which may, for example, range from two to eight, to hold and/or house the scanning device 507a. The height of the columns 506 should be high enough to capture tall human beings. These columns 506 may have a chain pulley device to help maneuver the scanning device 507a from top to bottom while scanning. Other 3D scanning technology may have extra non-moving scanning devices 507a to help capture the complete body or object. In another embodiment of this invention, these columns 506 may be attached to a metal base track 505 providing the flexibility to widen or reduce the scanning range for the scanning devices 507a. This enables zooming in closer to capture detailed head scans as well as scan larger objects or users. A platform 504 may be positioned in the center of the columns 506 where the object or user stands to ensure that the proper scanning is captured correctly. Other facets of body or object scanning, the 3D scanning applications and systems mentioned above are not meant as limitations to the implementation of the system 100.

In one embodiment to the present invention the 3D foot scanning cylinder 509 optionally scans both feet at the same time. Also, it may have a single foot configuration depending on the detail level of a 3D foot image file to be able to manufacture a 3D model, depending on the requirements. The 3D foot scanning system 509 may use the same 3D scanning technology that 3D imaging capturing cylinder 201a, 201b is using. The 3D foot scanning may use a rectangle box or columns to hold and/or house the scanning device 507b. This rectangle box or column 511 should be high and wide enough to capture a tall human being and/or large feet. A platform 510 may be positioned at the center of the rectangle box or column 511 where the user stands to ensure that the proper foot scanning is captured correctly. The applications and systems for foot scanning mentioned above are not meant as limitations to the implementation of the system 100.

The body scan data may be converted into a 3D image of the user or an “avatar.” Once the avatar is created, it may be uploaded and stored in the user's 3D digital image file. The user can then access the avatar from secured 3D digital image file and upload the avatar into a virtual world environment. In one embodiment of the present invention, these virtual world environments allow the user's avatar to engage in a number of virtual world activities, including but not limited to the purchase and sale of goods; engaging in art, entertainment, sporting, and various other social events; engaging in business opportunities that may or may not include the purchase or sale of goods and services. In another embodiment of the present invention, as the avatar's interaction with one or more virtual world environments becomes more frequent, software tracking a particular avatar's behavioral patterns, which may include but are not limited to types of purchases the avatar has made, particular virtual world environments the avatar frequents often, etc., translates these behavioral patterns into user preferences or “favorites” whenever the user engages his or her particular avatar in a virtual world environment.

In another embodiment of the present invention, the interface 106 serves as the gateway to connect users of the system 100 with other third-party virtual world entity 104. This interface 106 may use one or more communication technologies (e.g., web services 108 in conjunction with extensible mockup language (XML) or web browser plug-ins) and/or use a third party 3D web browser that would provide the ability for a two-way interaction between system 100 and a third party virtual world. The user's membership information (e.g., personal identification number (PIN)) stored in system 100 may be part of the interface to generate an entry key into other third party virtual world environments, while providing the ability for the member's 3D avatar to jump between virtual worlds. The 3D avatar may be stored in a shareable file format, such as a format adopted by standards organizations (e.g., the International Organization for Standardization (ISO)), so it can be used within the web 3D community. As the member's 3D avatar move between third party virtual worlds, the system 100 may collect statistical data so that the system 100 can keep track and learn which products and/or virtual environments the member enjoys, this data collection may also help provide the user with additional information, including but not limited to: discount coupons for apparel; 3D products that can be ordered using the virtual environment elements; and/or any equivalent thereof.

The following are various examples of how a user can use a 3D avatar in various virtual world environments.

### EXAMPLE 1

The user to use his/her 3D avatar for the creation of customized apparel. This provides the option for the user to load his or her 3D avatar in an interactive 3D virtual environment, such as a changing-room with apparel items from third-party entities 104. The user may apply various pieces of apparel and/or accessories on his/her avatar and view how it will look on him/her while also receiving apparel size information from the third-party entities 104.

### EXAMPLE 2

The user may use his/her 3D avatar to assume the role of an athlete in a virtual sport world. This provides the ability for the user to participate in a game with other system 100 users. While being an athlete in the virtual sport world, based on the progress of the user's avatar performance the user can receive sponsorships that will provide him with the funds to buy and wear additional apparel to help improve the user's performance.

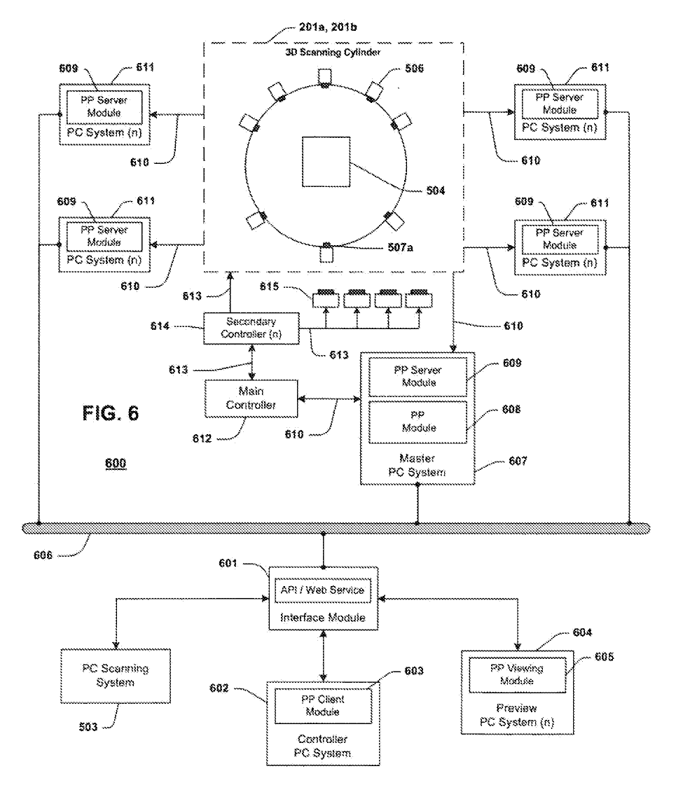

FIG. 6 illustrates another embodiment of this invention where multiple scanning devices 507a are utilized in a distributed parallel computing scanning system 600 to scan a user or object. The distributed parallel computing scanning system 600 is able to reduce several bottlenecks in the 3D model processing pipeline, such as but not limited to, the image download path, imaging processing CPU power, and storage I/O bandwidth. The 3D image capturing cylinder 201a, 201b is illustrated from a top view down with such components, the platform 504, columns (e.g., pillars, metal poles) 506, and scanning device(s) 507a. The columns 506 may be connected by a frame bridge ring that can house additional lighting source (e.g., LED panels, flash, etc.) or additional scanning device(s) 507a, depending on the range and details needed for the scan. A scanning device 507a may include several types of components, including but not limited to: high digital photo capturing camera; motion camera; and any other electronic boards. The cameras used inside the scanning device(s) 507a may be configured to capture each frame per second during the scanning session. The distributed parallel computing scanning system 600 uses a network 606 for communication and 3D data transfer. This network 606 may be a high speed TCP/IP network and/or any other protocol that provides many systems to communicate with each other.

The API/web service interface 601 may receive scanning job(s) from a command file from several systems through the network 606. This scan job command file may be formatted, including but not limited to, extensible mockup language (XML), comma delimited, and/or any equivalent thereof. One of these systems, the PC scanning system 503, may send scan job commands to the master PC system 607 to scan a user or object. The scan job commands may contain information such as the following: membership information; scanning location; distributed file location; local-setting information; or other information necessary to complete the scanning session. This API/web service interface 601 can be developed using an object oriented programming approach to deliver a scalable component such that objects can be accessed via many types of systems while still accomplishing the parallel processing requirements.

Beside PC scanning system 503, another option to communicate to the distributed parallel computing scanning system 600 is via the controller PC system 602 which resides outside of the system 100. The controller PC system 602 may send scan job commands to the master PC system 607. This controller PC system 602 may contain a (“parallel processing”) pp client module 603 that has a user interface that provides the retail store technician with several options, included but not limited to, initiate a scanning session, download the 3D image files, scanning status, any errors, and complete the rendering process for the 3D model. Before the retail store technician can start the scanning session, he/she may manually enter such information, including but not limited to, customer name, email, phone number, address, notes, and any other needed information. Then after entering the proper information, the retail store technicians can proceed with the scanning session when he/she presses the “start scan” option and monitor the progress of the parallel data processing of the scanned 3D files. The pp client module 603 includes the following functionalities but not limited to: store locally customer information, preview of scanned images, monitoring tool of the parallel data processing inside the master PC system 607 and PC systems 611, configuration user interface for the master PC system 607 and PC systems 611, file management, ability to retrieve scanned model from the parallel processing network, or any other administrative operation needed to manage the distributed parallel computing scanning system 600. On the network 606, PC systems 604 may be connected using an Ethernet cable to provide access for users to preview their scanned images. In one embodiment, the PC system 604 may include a built-in pp viewing module 605 that has some of the functionality from the pp client module 603. This viewing module 605 may contain the core functionalities to retrieve 3D model files from the distributed parallel computing scanning system 600 and may provide the user the ability to view them.

In one embodiment, the master PC system 607 is the main parallel processing system that contains two separate modules. The pp module 608 receives the scan job commands from the API/web service interface 601. The pp module 608 parses the scan job command and performs the proper scanning operation. Also, the pp module 608 may act as the parallel processing manager and communicate with the other PC systems 611. To provide for the time and storage space needed to process the 3D models efficiently, the distributed parallel computing scanning system 600 can be composed of several PC systems 611. The PC systems 611 may be connected through data cables (e.g., USB, FireWire IEEE 1394, etc.) 610 from one to several scanning device(s) 507a, depending on the parallel processing configuration.

In one embodiment of the present invention, after the pp module 608 completes parsing of the scan job commands and is ready to perform the scan of the user or object, it first communicates via data cable 610 to the main controller 612 to initial the scanning session. The main controller 612 may also include an electronic trigger device to allow the retail store technician to override the scan job command and manually do a scanning session. This provides the ability to test the distributed parallel computing scanning system 600 without requiring scan job commands and assist in the camera calibration process. Moreover, the main controller 612 may also be connected to several lighting sources (e.g., LED panels, flash) to control the turning on and off sequence of the lights individually and/or grouped together to improve the quality of the scan capture in the distributed parallel computing scanning system 600 configuration. This main controller 612 may be connected via custom cables 613 to secondary controllers 614 which may control capture sequence of the scanning device(s) 507a individually and/or grouped together during a scanning session. The main controller 612 and secondary controllers 614 may be implemented as hard-wired devices, as microprocessors specifically programmed to execute controller functions, or as software agents running in general purpose computers. Depending on the parallel processing configuration, several secondary controllers 614 may be used. These secondary controllers 614 may be connected via custom cables 613 to several pattern projectors with built-in texture flashes 615 to assist in capturing the proper scanning data. The custom cables 613 may be combined data cables with other required cables based on the scanning device(s) 507a being used in the distributed parallel computing scanning system 600. The secondary controllers 614 may be connected to one to many scanning device(s) 507a while sending the scan command to capture the scan of the user or object. When the scanning device(s) 507a finishes capturing the user or object, scan data may be transmitted via data cable 610 to PC systems 611 and master PC system 607. PC systems 611 as well as a master PC system 607 may include the pp server module 609. The pp server module 609 perform certain tasks, such as but not limited to, communication with the scanning device(s) 507a via data cable 610, downloading of images from the scanning device(s) 507a, reporting any errors and/or problems, processing specified images, saving the processed 3D model, registering the processed images, 3D model alignment, and notification to the pp module 608 with process status information. The pp module 608 may then close the scanning session and retrieve all the 3D model files to be stored locally on master PC system 607 to complete the 3D model alignment and have the 3D model available for any of the systems connected on the network 606. Modules being used in the distributed parallel computing scanning system 600, such as the pp client module 603, pp viewing module 605, pp module 608, and pp server module 609, may be developed using an object oriented programming approach to deliver a scalable component such that objects can be accessed via many types of systems. Also, the pp module 608 may communicate back to the system that sent the scanning job with scanning status information as well as any other information. The user may then request the 3D model from master PC system 607 for further use or viewing.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of creating, storing, and providing access to a 3D image using a computer connected to a network, said computer having a machine readable storage, having stored thereon a computer program comprising a plurality of code sections executable by a machine, said method comprising the steps of:
receiving 3D data generated through scanning of a person or object;
recording and formatting said data into a digital image file;
storing said digital image file in a 3D digital image file library located in said machine readable storage;
providing access to said 3D digital image file library;
retrieving said digital image file from said 3D digital image file library;
and uploading said digital image file into an interactive virtual world environment.

2. The method of claim 1 further comprising the step of electronically protecting said digital image file from public access through said network.

3. The method of claim 2 further comprising the step of creating a unique digital key to access said 3D digital image file library and providing said digital key to a user authorized to access said 3D digital image file library.

4. The method of claim 3 further comprising the step of transmitting a copy of said digital image file to said authorized user via said network upon presentation of said unique digital key.

5. The method of claim 1 further comprising the step of limiting access to said network only to users who are subscribing members of said network.

6. The method of claim 1 further comprising the step of recording said digital image file on an electronic card.

7. The method of claim 1 further comprising the step of formatting the digital image file by modifying or enhancing geometry and texture of said file.

8. The method of claim 1 further comprising the step of generating data related to mesh, color, texture, and rigging.

9. The method of claim 1, wherein the scanning of a person or object comprises applying laser and/or stereo-matching technology to obtain full body color data.

10. The method of claim 1, wherein the scanning of a person or object comprises photo capturing of close-up facial detail data.

11. The method of claim 1, wherein the scanning of a person or object comprises recording movement data corresponding to movement of person for a period of time; and further includes the step of storing said movement data in said digital image file.

12. The method of claim 11, wherein recording movement data comprises storing 3D point clouds of each frame per second during movement of the person.

13. A system for processing images comprising:
a plurality of devices for capturing an image or sequence of images of a target user or object;
a plurality of computers, electronically connected to said plurality of devices, for processing said image or sequence of images in parallel to compute a three-dimensional model of said target user or object; and
a module for receiving scanning requests and directing the operation of said plurality of computers.
a plurality of built-in texture flash projects for capturing an image or sequence of images of a target user or object;

14. The system of claim 13, further comprising:
a plurality of columns spaced around a platform, wherein each said column is used to position at least one device from said plurality of devices and
a frame bridge ring for connecting said columns and for optionally positioning cameras or lighting devices.

15. The system of claim 13, wherein at least one of the plurality of devices is configured to capture motion of said target user or object.

16. The system of claim 13, wherein the plurality of devices capture said image or sequence of images through a synchronized click mechanism.

17. The system of claim 13, wherein the plurality of devices comprise at least one high digital photo capturing camera.

18. The system of claim 13, wherein said requests comprise scan job commands.

19. The system of claim 18, wherein said module comprises a parallel processing module for parsing said scan job commands and directing a scanning job in accordance with said commands.

20. The system of claim 13, wherein the scanning requests are received from a client system.

21. The system of claim 18, wherein said module comprises a parallel processing module for retrieving one or more files corresponding to the three-dimensional model of said target user or object and completing alignment of said model.

22. The system of claim 1, where in said three-dimensional model includes movement data.

23. The system of claim 15, wherein said three-dimensional model includes movement data.

24. The system of claim 13, wherein said plurality of computers control a capture sequence of said plurality of devices and turn lighting sources on or off individually or collectively when capturing an image or sequence of images of a target user or object.

25. The system of claim 13, wherein said plurality of devices comprises a plurality of cameras.

26. The system of claim 13, wherein said plurality of devices comprises a plurality of pattern projectors with built-in texture flashes.
